(19) United States
(12) Patent Application Publication
(10) Pub. No.: US 2024/0105411 A1
(43) Pub. Date: Mar. 28, 2024

(54) STATUS DETECTION CIRCUIT AND REMOTELY OPERABLE SWITCH

(71) Applicant: TDK Electronics AG, München (DE)

(72) Inventor: Armin Grunack, Berlin (DE)

(21) Appl. No.: 18/263,768

(22) PCT Filed: Feb. 2, 2022
(86) PCT No.: PCT/EP2022/052430

§ 371 Date: Aug. 1, 2023

(30) Foreign Application Priority Data
Feb. 5, 2021 (DE) 10 2021 102 714.4

(51) Int. Cl. H01H 71/04; H01H 47/00; H01H 71/06

(52) U.S. Cl. CPC H01H 71/04; H01H 47/002; H01H 71/06; H01H 2071/048

(57) ABSTRACT

In an embodiment a state detection circuit includes a Hall sensor circuit with a Hall sensor, a voltage regulator and an output switch, wherein the Hall sensor circuit is connected between the voltage regulator and the output switch.

### CROSS-REFERENCE TO RELATED APPLICATIONS

This patent application is a national phase filing under section 371 of PCT/EP2022/052430, filed Feb. 2, 2022, which claims the priority of German patent application 102021102714.4, filed Feb. 5, 2021, each of which is incorporated herein by reference in its entirety.

### TECHNICAL FIELD

The invention relates to state detection circuits, e.g. for remotely operable switches, and to remotely operable switches having a corresponding state detection circuit.

### BACKGROUND

Remotely operable switches are circuit elements that can make an electrical contact between electrodes on demand or break an electrical connection between electrodes on demand. For this purpose, it is possible to control the switching state remotely.

Relays and power contactors represent possibilities to realize such remotely operable switches.

To control their function, it is generally desirable not only to control the switching state but also to output it, e.g. to detect the difference between the actual switching state and the target switching state in the event of a fault.

From International Patent Application Publication WO 2017/129823 A1, relays are known that have a read contact that is intended to be able to communicate the switching state of the relay to an external circuit environment.

From International Patent Application Publication WO 2020/043515 A1, power contactors are known whose circuit for communicating the actual switching state comprises a Hall switch.

Remotely operated switches, e.g. power contactors, generally have a control circuit that can switch a load circuit on and off. One possible use of such power contactors is to make or break the electrical connection between a battery and an electric motor, e.g., in an electric motor vehicle. Thus, the power contactor can have the function of a safety component where source and load, i.e. battery and electric motor, can be disconnected in case of a corresponding malfunction, especially at high voltages, e.g. 450 V.

For example, remote operable switches known from the above-mentioned publications are usually suitable for an operating voltage in the amount of 5 V. Furthermore, the current consumption is relatively high. Furthermore, there is a risk of damaging the electronics if the polarity of the connecting leads is reversed. In addition, the electronics can be destroyed by electrostatic charging and overvoltage pulses.

Furthermore, read contacts are a simple solution for outputting the switching state. However, the reliability of read contacts needs to be improved, especially in the presence of external magnetic fields.

Known remotely operable switches with Hall switches have the above disadvantages.

### SUMMARY

Embodiments provide switch state detection circuits. In particular, embodiments provide state detection circuits and corresponding remotely operable switches that have increased reliability without requiring the external circuit environment to be specifically adapted to improved remotely operable switches. Further embodiments provide remotely operable switches with reduced power consumption.

The state detection circuit includes a Hall sensor circuit having a Hall sensor. Furthermore, the state detection circuit has a voltage regulator and an output switch. The Hall sensor circuit is connected between the voltage regulator and the output switch.

With this interconnection configuration of Hall sensor circuit, voltage regulator and output switch, it is possible to specify a state detection circuit that can be specified not only for an operating voltage of 5 V, but for an operating voltage that can be in a wide voltage range. Furthermore, the current consumption is significantly reduced compared to known state detection circuits. While the current consumption of a state detection circuit of WO 2020/043515 A1 can be up to 20 mA, it is possible that the present state detection circuit has a maximum current consumption of 5 mA or less, e.g. 2.4 mA.

Via the voltage regulator, an external supply voltage can power the state detection circuit. The output switch can be used to communicate the switching state, e.g. of an associated remotely operable switch, to an external circuit environment.

Furthermore, it is possible to configure the connecting leads in such a way that the reverse polarity protection of the electronics of the status detection circuit is improved and thus will not be damaged even if incorrectly connected to an external circuit environment.

It is also possible to configure the sensitive components of the state detection circuit so that the electronics are not destroyed by an electrostatic charge and/or overvoltage pulses.

The state detection circuit as indicated above is fundamentally different from detection circuits such as those known from WO 2020/043515 A1. From WO 2020/043515 A1, for example, state detection circuits are known from FIG. 3B, in which an operational amplifier 203 is connected between a Hall sensor 19 and a semiconductor switch 207.

In contrast, the state detection circuit as described above specifies a configuration in which the Hall sensor, which is part of a Hall circuit, is connected between the voltage regulator and the output switch.

Moreover, there is no equivalent for the voltage regulator of the present state detection circuit in the detection circuit of WO 2020/043515 A1 and no equivalent of the operational amplifier 203 of WO 2020/043515 A1 in the state detection circuit as described above. Thus, the state detection circuit as described above is fundamentally different from the circuit topology of the detection circuit of WO 2020/043515 A1.

Due to the possibility that the state detection circuit can be operated with a wide range of a supply voltage as described above, the state detection circuit is universally applicable. Thus, it can also replace previous detection circuits without additional development effort to improve corresponding remotely operable switches and reduce power consumption. For example, the supply voltage range can be 4 V or more and 36 V or less.

It is possible that the Hall sensor provides a binary output signal.

The circuit configuration with the Hall sensor circuit between the voltage regulator and the output switch makes it possible to use as the Hall sensor an element that generates a binary output signal. The Hall sensor of WO 2020/043515 A1 is designed to supply a current for one switching state that is between 5 and 7 mA. To indicate the other switching state, the Hall sensor outputs a current that is between 12 mA and 17 mA. The Hall sensor of WO 2020/043515 A1 is thus a current source with a relatively high current consumption, while the binary output signal of the Hall sensor according to the present state detection circuit is easier to evaluate by subsequent circuit elements and enables lower energy consumption.

It is possible that the state detection circuit further comprises an output terminal. The output switch is then intended for, and of course correspondingly configured for, providing a switching state of a remotely operated switch in accordance with a magnetic environment of the Hall sensor at the output terminal.

The Hall sensor uses the Hall effect, i.e. the magnetic environment of the Hall sensor is detected.

Remotely operable switches, such as relays or power contactors, generally have a first electrode and a second electrode, and an electrical conductor whose position can be varied within the remotely operable switch. In particular, the electrical conductor can be mechanically brought into contact with the two electrodes to electrically connect the two electrodes and mechanically disconnected from at least one of the two electrodes to disconnect the electrical connection between the two electrodes. A magnet can be mechanically connected to the electrical conductor of the remotely operable switch, which changes its position in analogy to the electrical conductor depending on the switching state. In this case, the Hall sensor is preferably arranged in a fixed position relative to the remotely operable switch, so that when the switching state is changed, the distance between the magnet and a sensitive area of the Hall sensor also changes. Thus, when the remotely operable switch is activated, the magnetic environment of the Hall sensor changes. This information, which corresponds to the switching state of the associated remotely operable switch, can thus be provided to an external circuit environment at the output terminal of the state detection circuit.

The use of a Hall sensor here has the advantage that the Hall sensor operates without mechanical wear, which improves the reliability and service life of the state detection circuit.

It is possible that the state detection circuit further comprises a supply port and a ground terminal.

A supply voltage can be provided to the state detection circuit via the supply port. The ground port can be used to connect the status detection circuit to the ground potential of an external circuit environment.

Due to the configuration of the state detection circuit with the Hall sensor circuit between the voltage regulator and the output switch, it is possible that the supply port is suitable to accept a wide range of supply voltages to operate properly. It is possible that any voltage between 4 V and 36 V will suffice as an acceptable supply voltage to operate the state detection circuit.

It is possible that the Hall sensor is connected to three different lines of the Hall sensor circuit.

The configuration in which the Hall sensor is interconnected with three different lines of the Hall sensor circuit thus represents a circuit environment for the Hall sensor that differs substantially from the circuit environment around the Hall sensor of WO 2020/043515 A1. The circuit environment shown in FIG. 3B of WO 2020/043515 A1 clearly shows that the Hall sensor 19 is interconnected with exactly two lines of its circuit environment.

The state detection circuit as described above thus provides a new and improved configuration that increases reliability and reduces power consumption. It is possible that the Hall sensor is connected to ground and to the output switch and further electrically coupled to an output of the voltage regulator.

The connection to ground and to the output switch can be a direct connection. I.e. it is possible that the Hall sensor is connected directly to ground and directly to the output switch.

It is possible that the Hall sensor circuit further comprises a resistive element and a capacitive element. The resistive element may be connected between an output of the voltage regulator and a first terminal of the Hall sensor. The capacitive element may further be connected between the first terminal of the Hall sensor and ground.

The first resistive element may have a resistance between 50 n and 150 n, e.g. 100Ω. The capacitive element may have a capacitance between 5 nF and 15 nF, e.g. 10 nF. The capacitive element may have a nominal voltage of 50 V and thus operate smoothly in the voltage range between 5 V and 50 V.

It is possible that the resistive element and the capacitive element together form a member of an RC filter. This filter can reduce a ripple of a supply voltage of the voltage regulator and thus smooth the supply voltage of the Hall sensor.

It is possible that the state detection circuit further comprises a first diode. The first diode may be connected between the supply port and an input of the voltage regulator.

The first diode can be a reverse polarity protection diode, which protects the state detection circuit against damage in the event of incorrect reverse polarity. The protection against wrong polarity can be enabled up to a voltage of 60V. The forward voltage can be 0.5 V. The continuous current load can be 30 mA and the maximum short-time current load can be 2 A.

It is possible that the state detection circuit further comprises a first diode circuit between the output terminal and ground.

The first diode circuit can comprise two diodes connected in series in opposite directions. The first diode circuit can have a breakdown voltage of 40 V. The first diode circuit can protect the output switch from overvoltage.

Further, it is possible that the state detection circuit includes a second diode circuit. The second diode circuit may be connected between ground and the supply port.

The second diode circuit may also have two diodes arranged in opposite directions and connected in series.

The second diode circuit can have a breakdown voltage of 40 V. The second diode circuit can be designed as a bidirectional TVS diode. When its breakdown voltage is reached, the second diode circuit can become transparent and generate a short circuit to protect the circuit elements behind it from overvoltage. The state detection circuit is thus reliably protected against reverse polarity.

It is possible that the state detection circuit further comprises a second resistive element. The second resistive element may be connected between the first terminal of the Hall sensor and the second terminal of the Hall sensor.

The second resistive element may form a pull-up resistor of the Hall sensor and have a resistance between 50 kΩ and 150 kΩ, for example 100 kΩ. The second resistive element can serve to stabilize the output signal of the Hall sensor.

Further, it is possible for the state detection circuit to include a third resistive element. The third resistive element may be connected between ground and the output switch.

The third resistive element may have a resistance between 100Ω and 200Ω, for example 150Ω. Via the third resistive element, the output switch can obtain a coupling to ground so that its electrical potential is well-defined with respect to the ground potential.

It is possible that the output switch comprises a semiconductor switch and/or a protected semiconductor switch.

The semiconductor switch can be a field effect transistor (FET).

The semiconductor switch can have an operating voltage of 4 V to 60 V and is designed to forward the switching status information to an external circuit environment depending on the output signal of the Hall sensor, without the Hall sensor being directly connected to the external circuit environment.

In addition to the pure semiconductor switch, the output switch can have further protective elements that protect the semiconductor switch from impermissible operating parameters, for example both currents or excessively high voltages. I.e. the output switch can be or comprise a so-called Protected FET (ProFET).

It is possible that the voltage regulator is intended and configured for providing an output voltage that is between 3 V and 15 V for an input voltage between 4 V and 36 V. The output voltage of the voltage regulator may in particular be 5 V. The output voltage of the voltage regulator can be 5 V in particular. The voltage regulator essentially supplies the Hall sensor circuits with electrical energy.

It is possible that the Hall sensor of the Hall sensor circuit comprises a semiconductor switch and a Hall element connected to the gate terminal of the semiconductor switch. Also, the semiconductor switch of the Hall sensor may be a field effect transistor in this case.

This configuration, in which the Hall sensor is connected to its circuit environment via three lines, distinguishes the configuration of the present state detection circuit from corresponding detection circuits, for example of WO 2020/043515 A1.

Further, it is possible for the state detection circuit to comprise a second capacitive element. The second capacitive element may be connected between the supply port and ground.

The second capacitive element can have a capacitance of between 50 nF and 150 nF, for example 100 nF, and act as a smoothing capacitor to absorb high voltage peaks at the supply port of the status detection circuit. If the second capacitive element is charged appropriately, the second diode circuit can switch through and dissipate voltage peaks to ground.

A corresponding remotely operable switch may comprise an electrical switch and a state detection circuit, for example as described above. The state detection circuit is intended for and, by its special configuration, also configured of reliably detecting a switching state of the electrical switch and providing it to an external circuit environment.

It is possible that the remotely operable switch is selected from a relay, a contactor and a high-voltage contactor.

In this context, it is possible that, in the case of the remotely operable switch, the state detection circuit informs whether the switching state of the switch is “closed as intended” and/or “open as intended”.

This allows clear identification of whether the actual switching state is the same as the target switching state or whether there is a fault and the switch does not have an intended switch state (open or closed) but is open when it should be closed or closed when it should be open or has a state that is neither fully closed nor fully open.

The circuit elements of the state detection circuit may be arranged on one or both sides of a printed circuit board. The circuit board may be arranged in the bottom of the remotely operable switch. Further, the circuit board may have dimensions such that it fits within conventional remotely operable switches. In particular, the circuit board may be circular and have a diameter that is between 10 and 15 mm, for example 8.5 mm, 12.5 mm or 13.9 mm. Operating principles and details of preferred embodiments are shown in more detail in the following schematic figures.

It is possible that the remotely operable switch (FS) further comprises a tag on an electrical conductor. The conductor is intended and suitable for connecting the switch to an external circuit environment.

It is further possible that the conductor is a connecting lead and the marking is a warning label to warn against reverse polarity. In this case, such a label represents a possible configuration that improves the protection against polarity reversal.

### BRIEF DESCRIPTION OF THE DRAWINGS

In particular:

FIG. 1 shows the arrangement of some circuit blocks relative to each other;

FIG. 2 shows the circuit diagram with further circuit elements of a preferred embodiment;

FIG. 3 shows the circuit environment of the Hall element in the Hall sensor;

FIG. 4 shows functional elements of a remotely operable switch; and

FIG. 5 shows circuit elements of another preferred embodiment.

### DETAILED DESCRIPTION OF ILLUSTRATIVE EMBODIMENTS

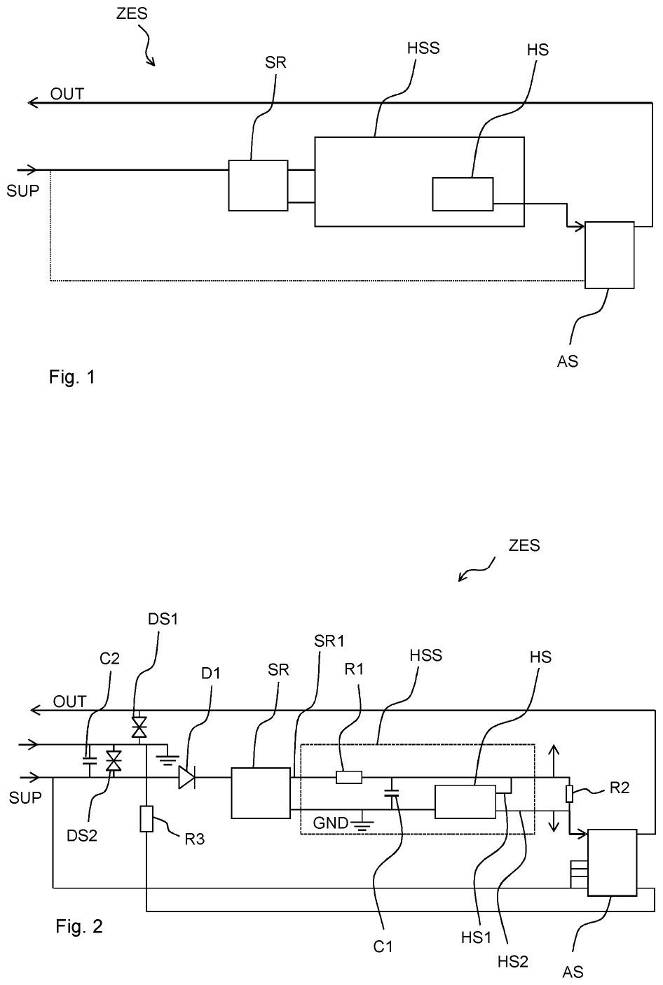

FIG. 1 shows blocks of the state detection circuit ZES. The state detection circuit includes a voltage regulator SR, a Hall sensor circuit HSS and an output switch AS. In this case, the Hall sensor circuit includes a Hall sensor HS. The Hall sensor circuit HSS is connected between the voltage regulator SR and the output switch AS. The state detection circuit further has an input SUP for a supply voltage and an output OUT to forward the switching state to an external circuit environment. The output switch AS is thereby connected between the Hall sensor circuit HSS and the output terminal OUT. Optionally, the output switch AS is connected to the supply port SUP.

The directions of the arrows on the supply port SUP and on the output port OUT indicate the direction of the corresponding electrical power.

The configuration with the Hall sensor circuit and its Hall sensor between the voltage regulator and the output switch makes the state detection circuit fundamentally different from corresponding state detection circuits from known remotely operable switches. As a result of the new configuration, it is possible for the state detection circuit to have lower power requirements and increased reliability while still being compatible with previous remotely operable switches.

FIG. 2 shows an embodiment of the state detection circuit ZES with further circuit elements. Thus, there is a further terminal which can be connected to ground potential. In particular, the voltage regulator SR, the Hall sensor circuit HSS and the output switch AS can be connected to ground.

In the Hall sensor circuit HSS, a first terminal HS1 of the Hall sensor HS is connected to a first output terminal SRI of the voltage regulator SR via a first resistive element R1. A second terminal HS2 of the Hall sensor circuit HSS is connected to an input of the output switch AS. A further connection of the Hall sensor HS is connected to ground.

The first capacitive element C1 is connected between the first terminal HS1 of the Hall sensor HS and ground. The pull-up resistor R2 is connected between the first terminal HS1 of the Hall sensor HS and the second terminal HS2 of the Hall sensor HS.

The first diode Di is connected between the supply port SUP and the voltage regulator SR. The first diode Di represents a reverse polarity protection diode against incorrect polarity reversal of the status detection circuit.

The first diode circuit DS1 is connected between the output terminal OUT and ground. The first diode circuit DS1 provides protection against overvoltage. In particular, the first diode circuit DS1 can protect the output switch AS against overvoltage.

The second diode circuit DS2 is connected between the supply port SUP and ground. The second diode circuit DS2 protects the circuit elements behind it against overvoltage at the supply port SUP. Voltage peaks are discharged to ground when the breakdown voltage of the second diode circuit DS2 is exceeded.

The third resistive element R3 is connected between ground and the output switch AS and provides a defined potential to the output switch AS with respect to ground.

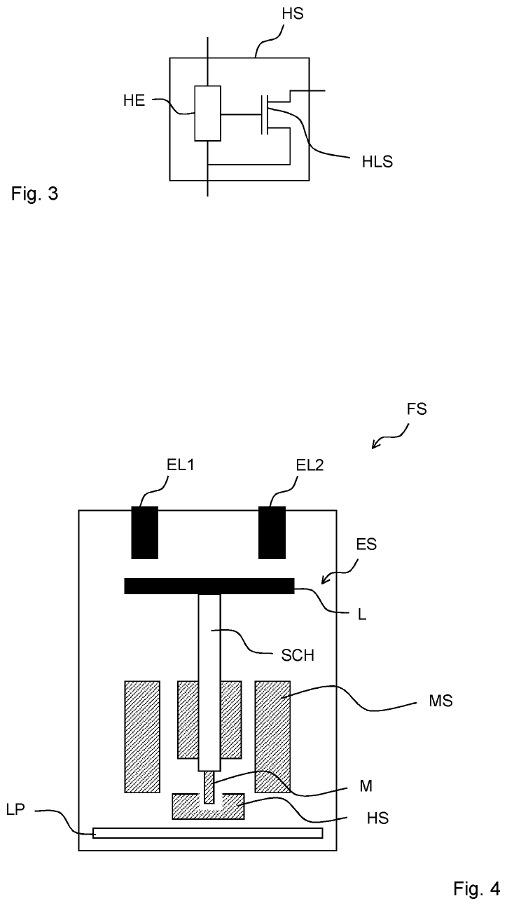

FIG. 3 shows a possible internal structure of the Hall sensor HS. It may contain a Hall element HE and a semiconductor switch HLS. The Hall element HE is arranged near a rest position of a magnet on the movable electrical conductor of the remotely operable switch and detects magnetic fields in its vicinity. The Hall element HE is connected to the base of the semiconductor switch HLS. In total, the Hall sensor HS is connected to its circuit environment via three lines and provides a binary output signal at its output via the semiconductor switch HLS with respect to the magnetic environment of the Hall element. The semiconductor switch HLS of the Hall sensor HS is thereby essentially coupled or directly connected to the output switch AS.

FIG. 4 shows central elements of a remotely operable switch FS. The remotely operable switch FS has a first electrode EL1 and a second electrode EL2 as well as an electrical conductor L. The electrical conductor L can be attached to a thrust element SCH. Via the thrust element SCH, the electrical conductor can be pressed against the first electrode EL1 and against the second electrode EL2 or pulled away from the electrodes EL1, EL2, for example driven by solenoid coils MS. This allows the remotely operable switch to close or open an electrical contact between electrodes EL1 and EL2. The solenoid coils MS can be remotely controlled by appropriate currents. Permanently connected to the thrust element SCH is a magnet M, which also changes its position depending on the position of the electrical conductor L, thus changing the magnetic environment of the Hall sensor HS. Based on its magnetic environment, the Hall sensor HS can transmit a binary signal relating to the switching state of the electrical conductor L to the external circuit environment. The circuit elements or circuit blocks of the state detection circuit may be arranged on one or both sides of a circuit board LP, which is connected to the Hall sensor HS. The circuit board LP may be arranged and fixed in the bottom portion of the remotely operable switch FS. In this regard, the circuit board LP may have a size and a shape such that it is usable in corresponding recesses in common remotely operable switches FS. Thus, the power consumption of common remotely operable switches can be reduced and the reliability can be increased without requiring any redesign of the other switch elements of the switch ES.

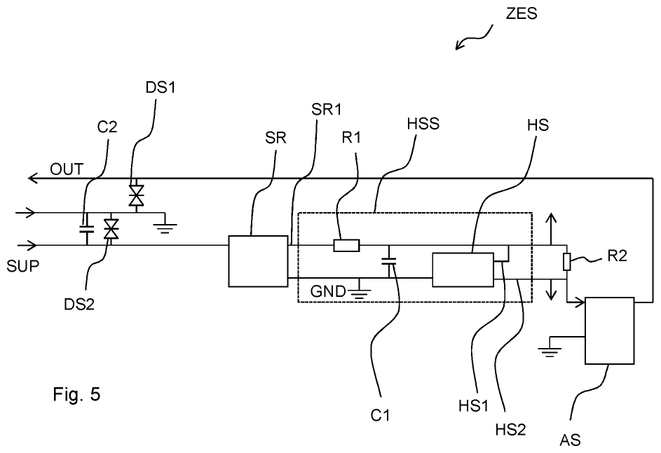

FIG. 5 shows a preferred form of a state detection circuit based on the circuit shown in FIG. 2. For example, compared to the circuit of FIG. 2, the output switch of the circuit of FIG. 5 is connected directly to ground instead of to the supply port SUP. Furthermore, the circuit according to FIG. 5 lacks the third resistive element R3 and the output switch of the circuit according to FIG. 5 lacks the corresponding connection via R3 to ground. The first diode Di of the circuit according to FIG. 2 is no longer included in the embodiment according to FIG. 5.

The resistance value of the second resistive element R2 can be between 2 kΩ and 10 kΩ, e.g. 4.7 kΩ. The output switch AS can be designed as a three-pole (semiconductor) switch, e.g. as a Pro(tected) FET.

The state detection circuit and the remotely operable switch are not limited to the described embodiments. The state detection circuit may have other circuit elements, for example for detecting temperature or a voltage applied to the housing of the corresponding switch for detecting a fault.

1-21. (canceled)

22. A state detection circuit comprising:
a Hall sensor circuit with a Hall sensor;
a voltage regulator; and
an output switch,
wherein the Hall sensor circuit is connected between the voltage regulator and the output switch.

23. The state detection circuit according to claim 22, wherein the Hall sensor is configured to provide a binary output signal.

24. The state detection circuit according to claim 22, further comprising an output terminal, wherein the output switch is configured to provide a switching state of a remotely operated switch at the output terminal according to a magnetic environment of the Hall sensor.

25. The state detection circuit according to claim 22, further comprising a supply port and a ground terminal.

26. The state detection circuit according to claim 25, further comprising a first diode between the supply port and an input of the voltage regulator.

27. The state detection circuit according to claim 25, further comprising a second diode circuit between ground and the supply port.

28. The state detection circuit according to claim 25, further comprising a second capacitive element connected between the supply port and ground.

29. The state detection circuit according to claim 22, wherein the Hall sensor is connected to three different lines of the Hall sensor circuit.

30. The state detection circuit according to claim 29, wherein the Hall sensor is connected to ground and the output switch, and wherein the Hall sensor is electrically coupled to an output of the voltage regulator.

31. The state detection circuit according to claim 22,
wherein the Hall sensor circuit further comprises a resistive element and a capacitive element,
wherein the resistive element is connected between an output of the voltage regulator and a first terminal of the Hall sensor, and
wherein the capacitive element is connected between the first terminal of the Hall sensor and ground.

32. The state detection circuit according to claim 22, further comprising a first diode circuit between an output terminal and ground.

33. The state detection circuit according to claim 22, further comprising a second resistive element between a first terminal of the Hall sensor and a second terminal of the Hall sensor.

34. The state detection circuit according to claim 22, further comprising a third resistive element between ground and the output switch.

35. The state detection circuit according to claim 22, wherein the output switch comprises a semiconductor switch and/or a protected semiconductor switch.

36. The state detection circuit according to claim 22, wherein the voltage regulator is configured to provide, at an input voltage between 4 V and 36 V, an output voltage that is between 3 V and 15 V or that is 5 V.

37. The state detection circuit according to claim 22, wherein the Hall sensor comprises a semiconductor switch and a Hall element connected to a gate terminal of the semiconductor switch.

38. A remotely operable switch comprising:
an electrical switch; and
the state detection circuit according to claim 22 configured to provide a switching state of the electrical switch.

39. The remotely operable switch according to claim 38, wherein the remotely operated switch is a relay, a contactor or a high voltage contactor.

40. The remotely operable switch according to claim 38, wherein the state detection circuit is configured to inform whether the switching state of the switch is closed as intended and/or is open as intended.

41. The remotely operable switch according to claim 38, further comprising a tag on an electrical conductor configured for connecting the switch to an external circuit environment.

42. The remotely operable switch according to claim 41, wherein the conductor is a connecting lead and a label is a reverse polarity warning label.
